(19) United States
(12) Patent Application Publication
(10) Pub. No.: US 2005/0095397 A1
(43) Pub. Date: May 5, 2005

(54) Glass weather strip for vehicle

(76) Inventors: Hitoshi Omori, Nishikasugai-gun (JP); Tomohiro Takase, Nishikasugai-gun (JP)

Correspondence Address: POSZ LAW GROUP, PLC, 11250 ROGER BACON DRIVE, SUITE 10, RESTON, VA, 20190, US

(21) Appl. No.: 10/936,815

(22) Filed: Sep. 9, 2004

(30) Foreign Application Priority Data
Sep. 9, 2003 (JP) P2003-316263

(51) Int. Cl. B32B 1/04

(52) U.S. Cl. 428/122

(57) ABSTRACT

A glass weather strip for a vehicle is provided for holding or sealing a sliding window glass of a vehicle. The glass weather strip is made of at least two layers of a base layer and a surface layer formed on the base layer on which a window glass slides, in the area where the window glass slides through the glass weather strip, the base layer is made of a thermoplastic elastomer softer than the surface layer, the surface layer is made of a thermoplastic elastomer harder than the base layer and containing short fibers dispersed therein.

This application is based on Japanese Patent Application No. 2003-316263, which is incorporated herein by reference.

### BACKGROUND OF THE INVENTION

1. Field of the Invention

The present invention relates to a weather strip for a vehicle, which seals up between a window glass and a door or body of a vehicle and which, when the window glass is opened or closed, is kept in contact with the window glass that slides on it.

2. Description of the Related Art

Window glasses of a vehicle are opened and closed for ventilating the room, etc. A glass weather strip for a vehicle such as a door glass run, an outer weather strip and an inner weather strip is used for holding the window glass that moves up and down or slides for opening and closing so as to seal up between the window glass and the door or the body of the vehicle.

When the window glass of the vehicle is opened and closed, its window glass is moved up and down or slid through the seal lips of the glass weather strip. If the friction resistance between the window glass and the glass weather strip is large when the window glass is slid, then the window glass is difficult to open and some unnatural force may be applied to the window glass when the window glass is opened, and some noise may occur. If so, in addition, the surface of the glass weather strip may be worn, and it may soil the surface of the window glass and its sealability lowers. Accordingly, the surface part of the glass weather strip on which the window glass slide is processed for lowering the friction power thereof.

For example, short fibers of nylon or the like are mounted on the surface of a glass weather strip with an adhesive (e.g., see JP-A-5-305815). In this case, the fiber-mounting step on the surface of the glass weather strip takes much time and labor and increases production costs. Another problem is that the adhesive applied to a weather strip for mounting short fibers thereon may often irregularly jut out to worsen the outward appearance of the finished weather strip. Still another problem is that dust and sand may be caught by the mounted short fibers in long-term use, and they may rub against the window glass to scratch it or give noise, and, in addition, the mounted short fibers may be dropped off or the adhesive may be peeled off.

A coating material of low friction resistance, such as urethane or silicone-based material may be applied to the surface of the glass weather strip. Also in this case, the coating step is takes superfluous labor and therefore increases production costs. In addition, even though coated with the coating material, they could not ensure good durability since the coating material is worn and the substrate is exposed out after long-term use. This is because the coating material could not form a layer having a satisfactory thickness.

Further, a method of forming a resin layer on the surface of a substrate by extrusion is proposed, in which the resin layer is made of a low-friction material of polyolefin or nylon resin that contains inorganic powder or particles of mica, molybdenum, graphite or the like or contains resin powder or particles of nylon, urethane, polyolefin, polystyrene or the like (e.g., see JP-A-8-25452). In this case, the surface of the resin layer is irregularly roughened by the powder or grains added thereto, and the contact area thereof with the surface of the window glass is reduced and the sliding resistance of the window glass is thereby lowered. However, the powder or particles added to the resin layer are substantially spherical or polyhedral, and when the resin layer is worn by a window glass after long-term use, then the powder or particles may be exposed out of the surface of the resin layer and, after the resin layer is further worn, the powder or particles may be dug out and may be readily dropped off from the resin layer, and as a result, the resin layer could not ensure satisfactory low friction for a long period of time.

### SUMMARY OF THE INVENTION

The present invention is to provide a glass weather strip for a vehicle which is for sealing up a window glass and for holding a sliding window glass, and which ensures satisfactory low sliding resistance for a long period of time when the window glass sealed up with it is opened and closed.

To solve the above-mentioned problems, the invention provides a glass weather strip for a vehicle which is for holding or sealing a sliding window glass of a vehicle, the glass weather strip comprises a base layer made of a first thermoplastic elastomer softer than a surface layer, or of a solid or slightly-foamed ethylene-propylene rubber (EPDM, ethylene-α-olefin-nonconjugated-diene copolymer), the surface layer formed on the base layer on which the window glass slides, and the base layer and the surface layer are laminated in a part the glass weather strip on which the window glass slides and the surface layer is made of a second thermoplastic elastomer harder than the base layer and containing short fibers dispersed therein to roughen a surface of the surface layer.

In the area where the window glass slides through it, the glass weather strip of the invention is made of at least two layers of the base layer and the surface layer formed on the base layer on which the window glass slides, and it therefore satisfies good slidability of window glasses through it and good flexibility of itself to door frames and vehicle bodies. Specifically, the base layer is made of a thermoplastic elastomer softer than the surface layer, or of a solid or slightly-foamed ethylene-propylene rubber (EPDM), and therefore the glass weather strip is flexible as a whole and can be well fitted to door frames and vehicle bodies along their shape.

The surface layer on which window glasses slide is made of a thermoplastic elastomer harder than the base layer, and therefore it lowers the sliding resistance thereof to window glasses and its wearing may be reduced. Further, since the surface layer contains short fibers dispersed therein, its surface is roughened by the short fibers. This means that the contact area between the surface layer of the glass weather strip and the edges and the surface of window glasses may be reduced, and therefore the sliding resistance between window glasses and the glass weather strip may be further reduced. Even when the surface layer is worn by the window glasses sliding on it to lose its surface roughness and some short fibers are partly exposed out of it, the sliding resistance of the surface layer does not still increase since the short fibers are harder than the surface layer. In addition, since a major part of the short fibers are embedded in the surface layer, they are not dugout of the surface layer by window glasses sliding thereon, different from power or granules, and therefore the surface layer containing them can ensure low sliding resistance for a long period of time.

Preferably, the short fibers in the surface layer comprise at least one of fluororesin fibers, polyamide fibers, aromatic polyamide fibers, polyester fibers, acrylic fibers, carbon fibers and glass fibers.

In this embodiment, the short fibers are those of one or more types of fluororesin fibers, polyamide fibers, aromatic polyamide fibers, polyester fibers, acrylic fibers, carbon fibers and glass fibers. In this, therefore, even when the short fibers are exposed out of the surface layer, the sliding resistance of the surface layer to window glasses is still low and the surface layer is still resistant to wearing and has good durability. For these reasons, the glass weather strip of the type enjoys smooth opening and closing of window glasses, and the surface layer thereof is prevented from being worn for a long period of time.

Also preferably, the short fibers in the surface layer have a diameter of from 5 μm to 30 μm and a length of from 100 μm to 1000 μm.

In this embodiment, the short fibers have a diameter of from 5 μm to 30 μm. This means that the thickness of the short fibers is enough to reduce the sliding resistance of the surface layer to window glasses even when the short fibers are exposed out of the sliding face of the surface layer, and that the stiffness of the short fibers is high and the hardness of the surface layer that contains the short fibers is therefore high. In this, in addition, the short fibers have a length of from 100 μm to 1000 μm. This means that the length of the short fibers is enough not too much increase their resistance when they are added to a thermoplastic elastomer and is enough not to drop off from the thermoplastic elastomer. The short fibers tend to be oriented in the longitudinal direction during resin extrusion with them, and therefore the projections formed on the sliding face of the surface layer may be aligned in the longitudinal direction and they may reduce the siding resistance in the longitudinal direction of the surface layer. Needless-to-say, a major part of the short fibers having the size as above are embedded in the surface layer and do not easily drop off. Accordingly, the surface layer ensures satisfactory low sliding resistance for a long period of time.

Also preferably, the short fibers have a melting point higher than that of the second thermoplastic elastomer.

In this embodiment, the melting point of the short fibers is higher than that of the material of the surface layer in which they are dispersed. In this, therefore, the short fibers do not dissolve in the thermoplastic elastomer even when they are heated and dispersed in it. After added to the thermoplastic elastomer, the fibers may still keep their fibrous condition and act to reduce the sliding resistance of the surface layer and, in addition, they are kept long and do not easily drop off from the surface layer.

Also preferably, the hardness of the base layer of the glass weather strip of the invention is from 60° to 85° in terms of the JIS A-type spring hardness Hs, and the hardness of the surface layer thereof is from 35° to 50° in terms of the Shore D-type hardness.

In this embodiment, the hardness of the base layer is from 60° to 85° in terms of the JIS A-type spring hardness Hs. This means that the base layer that accounts for a major part of the glass weather strip of the invention is soft, and therefore the glass weather strip may be well fitted to a door frame or vehicle body along the shape thereof and the fitting work is easy. After fitted thereto, the glass weather strip is flexible and soft to window glasses and has good sealability. The hardness of the surface layer the glass weather strip is from 35° to 50° in terms of the Shore D-type hardness. This means that the hardness of the part of the glass weather strip on which window glasses slide is kept high, and the sliding resistance of that part to window glasses is kept low, and therefore the glass weather strip is prevented from being worn. In addition, since the hardness of the surface layer alone is high, it does not detract from the overall flexibility of the glass weather strip as a whole.

When the base layer is made of an olefin-based thermoplastic elastomer (TPO), it is desirable that TPO for the base material for it is prepared by kneading from 60 parts by weight to 85 parts by weight of a softener-containing EPDM rubber component and from 15 parts by weight to 40 parts by weight of a polypropylene resin, and the surface layer is made of a material prepared by kneading 100 parts by weight of TPO that comprises from 30 parts by weight to 60 parts by weight of a softener-containing EPDM rubber component and from 40 parts by weight to 70 parts by weight of a polypropylene resin, along with from 2 to 10 parts by weight of a filler that contains at least short fibers.

In this embodiment, TPO for the base material for the base layer is prepared by kneading from 60 parts by weight to 85 parts by weight of a softener-containing EPDM rubber component and from 15 parts by weight to 40 parts by weight of a polypropylene resin. This means that the EPDM rubber content of the base layer is large and therefore the base layer is flexible. Since the material for the layer is prepared by kneading such EPDM rubber and polypropylene resin, its weather resistance is good and, in addition, the two components are well miscible with each other and are readily kneaded and mixed. The surface layer is made of a material prepared by kneading 100 parts by weight of TPO that comprises from 30 parts by weight to 60 parts by weight of a softener-containing EPDM rubber component and from 40 parts by weight to 70 parts by weight of a polypropylene resin, along with from 2 to 10 parts by weight of a filler that contains at least short fibers. This means that the olefin-based material for the surface layer is the same type as that of the olefin-based material for the base layer, and the surface layer well adheres to the base layer. When the base layer is made of TPO, then it is easy to form the surface layer thereon by extrusion. In the surface layer, from 2 to 10 parts by weight of a filler that contains short fibers is kneaded, and the surface of the surface layer is thereby roughened. Even though the short fibers having a low friction resistance are exposed out of the sliding face of the surface layer, the sliding resistance of the surface layer may be kept low. In addition, when a lubricant is added to the filler along with short fibers, then the sliding resistance of the surface layer may be further reduced. Since the amount of the filler to be in the surface layer is at least 2 parts by weight, the surface layer may have a satisfactorily-lowered sliding resistance; and since the amount is at most 10 parts by weight, the surface layer is kept flexible and is readily formed through extrusion, and, when the molded parts are bonded together to construct the structure, the filler does not have any negative influence on the bonding strength of the bonded parts.

The glass weather strip of the invention may be a glass run of a vehicle including a body portion having a substantially U-shaped cross section comprises a bottom wall fitted to an inner periphery of a vehicle door frame and side walls having opposing faces to each other and seal lips each extending obliquely from each side wall toward the inside of the U-shaped body portion so as to face each other, wherein a surface layer roughened by the short fibers is formed on at least an inner face of the bottom wall.

In this embodiment, the glass weather strip is a glass run of a vehicle that comprises a body portion and seal lips, in which the body portion comprises a bottom wall and two side walls facing each other, and has a substantially U-shaped cross section, and a surface layer is formed on at least the faces of the seal lips that face each other and on the inner face of the bottom wall. This means that, when a door window glass is slid up and down inside the glass run that has a substantially U-shaped cross section, the sliding resistance of the surface layer of the seal lips through which the door window glass slides may be kept low. Accordingly, the door window glass can be smoothly slid up and down with no noise. In addition, since the base layer of the seal lips is flexible, door window glasses can be well held by the seal lips while kept in airtight contact with them, and the sealability of the seal lips is good. Further, the seal lips are readily fitted to door frames as they well follow the shape of door frames to which they are fitted.

Preferably, the surface layer in the glass weather strip of the invention is made of a material prepared by kneading 100 parts by weight of a third olefin-based thermoplastic elastomer (TPO) that comprises from 30 parts by weight to 60 parts by weight of a softener-containing EPDM rubber component and from 40 parts by weight to 70 parts by weight of a polypropylene resin, along with from 2 to 10 parts by weight of a filler that contains at least short fibers and a lubricant, and a surface of surface layer is roughened by the short fibers.

In this embodiment, the surface layer is made of a material prepared by kneading 100 parts by weight of an olefin-based thermoplastic elastomer (TPO) that comprises from 30 parts by weight to 60 parts by weight of a softener-containing EPDM rubber component and from 40 parts by weight to 70 parts by weight of a polypropylene resin, along with from 2 to 10 parts by weight of a filler that contains at least short fibers and a lubricant. Accordingly, the surface of the surface layer is roughened by the short fibers, and the contact area of the surface layer with window glasses is thereby reduced, In addition, since TPO that covers the short fibers contains a lubricant, the sliding resistance of the surface layer in this embodiment may be lower than that of the surface layer made of TPO alone.

Also preferably, the filler for the surface layer contains short fibers and a lubricant in the ratio of approximately 1/1, and is kneaded in the third olefin-based thermoplastic elastomer (TPO).

In this embodiment, the ratio of the short fibers and the lubricant to be in TPO for the surface layer is in the ratio of approximately 1/1, the lubricant in TPO acts to prevent the initial abrasion of the roughened surface of the surface layer, and after a part of the short fibers have been exposed out, they act to prevent the abrasion of the surface layer.

In the glass weather strip for a vehicle of the invention, at least the surface layer is made of a thermoplastic elastomer harder than the base layer and containing short fibers dispersed therein to roughen the surface of the layer. Therefore, the sliding resistance to window glasses of the surface layer of the glass weather strip may be kept satisfactorily low for a long period of time. Specifically, in the initial stage, the sliding resistance of the glass weather strip is kept low since the contact area of the surface layer with window glasses is reduced in the roughened surface of the surface layer made of TPO. Even after the roughened surface of the surface layer has been worn away and a part of the short fibers have been exposed out of the surface layer, the surface layer may still keep the reduced sliding resistance thereof since the short fibers have a low sliding resistance. Moreover, since a major part of the short fibers are embedded in the surface layer, they do not easily drop off from the surface layer, and therefore the surface layer may keep the reduced sliding resistance thereof for a long period of time. Preferably, the short fibers have a diameter of from 5 μm to 30 μm and a length of from 100 μm to 1000 μm. Also preferably, the surface layer is made of a material prepared by kneading 100 parts by weight of an olefin-based thermoplastic elastomer (TPO) that comprises from 30 parts by weight to 60 parts by weight of a softener-containing EPDM rubber component and from 40 parts by weight to 70 parts by weight of a polypropylene resin, along with from 2 to 10 parts by weight of a filler that contains at least short fibers and a lubricant. Also preferably, the ratio of the short fibers and the lubricant to be added to TPO for the surface layer is approximately 1/1. In the glass weather strip for a vehicle of the invention having the constitution as above, the short fibers are prevented from dropping off from the surface layer, and the lubricant added to the surface layer ensures the reduced sliding resistance of the layer for a long period of time and ensures improved abrasion resistance of the layer.

### BRIEF DESCRIPTION OF THE DRAWINGS

FIG. 1 is a front view of a door of a vehicle;

FIG. 2 is a cross-sectional view of FIG. 1 that has a glass run fitted thereto, as one embodiment of the invention, cut along the line II-II; and

FIG. 3 is a cross-sectional view of FIG. 1 that has an outer weather strip and an inner weather strip fitted thereto, as another embodiment of the invention, cut along the line III-III.

### DETAILED DESCRIPTION OF THE PREFERRED EMBODIMENTS

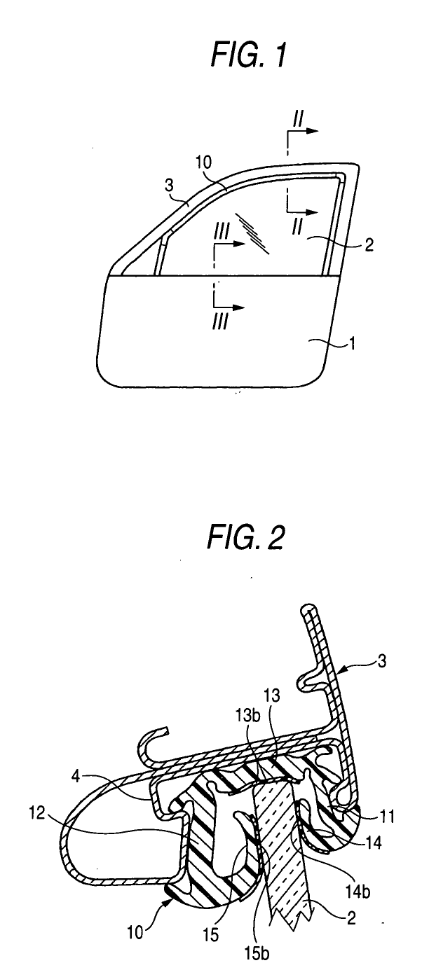

Preferred embodiments of the invention are described hereinunder with reference to FIG. 1 to FIG. 3 attached hereto, The invention relates to a weather strip for a vehicle, which seals up window glasses that are opened and closed, and holds a window glass that slides up and down in the window glass, and which has a sliding part on which the window glass slides when the window glass is opened and closed. A door window glass weather strip that seals up the sliding window glass in a door window glass is described as one example of the invention. Not limited to it, the invention may apply to any other glass weather strips such as those for sliding window glasses mounted to vehicle bodies.

FIG. 1 is a front view of a door 1 of a vehicle. The first embodiment of the invention described herein is a glass run 10, a type of a glass weather strip to be fitted to the inner periphery of a door frame 3. FIG. 2 is a cross-sectional view of FIG. 1 cut along the line II-II. The glass run 10 is fitted into the channel 4 formed in the inner periphery of the door frame 3. The glass run 10 comprises an outer side wall 11, a bottom wall 13 and an inner side wall 12, and its body portion has a substantially U-shaped cross section. An outer seal lip 14 extends obliquely from the top end of the outer side wall 11 toward the inside of the U-shaped body portion. Similarly, an inner seal lip 15 extends obliquely from the top end of the inner side wall 12 toward the inside of the U-shaped body portion. The outer seal lip 14 and the inner seal lip 15 face each other inside the U-shaped body portion, and their outer faces are the facing sides thereof, A window glass 2 is inserted into the space of the facing sides of the two seal lips.

Of the glass run 10, the part that is fitted to the upper side of the door frame 3 is so designed that, when the window glass 2 slides up in the door frame, its top end finally enters the distance between the facing sides of the outer seal lip 14 and the inner seal lip 15 to seal up the window glass 2. The part of the glass run 10 that is fitted to the side walls of the door frame 3 is so designed that, when the window glass 2 slides up and down in the door frame, its side edges run between the outer seal lip 14 and the inner seal lip 15 while kept in contact with them.

In this embodiment, the inner face of the bottom wall 13 and the facing sides of the outer seal lip 14 and the inner seal lip 15, on which the top end and the side edges of the window glass 2 slide, are integrated with surface layers 13b, 14b and 15b, respectively, as will be described hereinunder. The surface layers 13b, 14b and 15b are harder than the base layer of the other part of the glass run 10, and is made of an olefin-based thermoplastic elastomer (TPO-hereinafter this is referred to as TPO) that contains short fibers dispersed therein. Accordingly, the sliding resistance of the surface layers 13b, 14b and 15b may be reduced.

The material of the glass run 10 is described. The material of the base layer that is the other part than the surface layer of the glass run 10 is made of a soft thermoplastic elastomer, or a solid or slightly-foamed ethylene-propylene rubber (EPDM rubber). The thermoplastic elastomer includes TPO, styrene-based thermoplastic elastomer, polyamide-based thermoplastic elastomer, and polyvinyl chloride-based thermoplastic elastomer, and TPO is preferred. Preferably, TPO for the base material of the base layer is prepared by kneading, for example, from 60 parts by weight to 85 parts by weight of a softener-containing EPDM rubber component and from 15 parts by weight to 40 parts by weight of a polypropylene resin to be 100 parts by weight of TPO in total. Also preferably, the hardness of the base layer is from 60° to 85° in terms of the JIS A-type spring hardness. Concretely, for example, 70 parts by weight of a softener-containing EPDM rubber component is kneaded with 30 parts by weight of a polypropylene resin, to form the base layer, and the hardness of the base layer is 70° in terms of the JIS A-type spring hardness.

When TPO is used in the base layer, then the glass weather strip formed has good weather resistance and is inexpensive. If, however, the amount of the EPDM rubber component is smaller than 60 parts by weight and that of the polypropylene resin is larger than 40 parts by weight and when the two are kneaded in that ratio to form the base layer, then the JIS A-type spring hardness of the base layer formed will be larger than 85°. If so, the glass run 10 will be hard and the seal lips 14 and 15 of the glass run 10 will lose flexibility and sealability and, as a result, the glass run 10 will be difficult to fit into the channel 4. On the other hand, if the amount of the EPDM rubber component is larger than 85 parts by weight and that of the polypropylene resin is smaller than 15 parts by weight and when the two are kneaded in that ratio to form the base layer, then the JIS A-type spring hardness of the base layer formed will be smaller than 60°. If so, the glass run 10 will be too soft, and therefore could not be satisfactorily stiff when fitted into the channel 4, and it may be readily out of the channel 4. If so, in addition, the seal lips 14 and 15 will be readily rolled up inside the glass run 10 along with the window glass 2 that slides up into it. The material of the base layer may also be a solid or slightly-foamed ethylene-propylene rubber (EPDM rubber) having a JIS A-type spring hardness of from 60° to 80°. Since the EPDM rubber is a type of polyolefin, the base layer made of EPDM rubber and the surface layer made of TPO may well bond to each other.

The material of the surface layers 13b, 14b and 15b on the surfaces of the bottom wall 13, the outer seal lip 14 and the inner seal lip 15 is made of a thermoplastic elastomer. However, this is harder than the material of the base layer. Like that for the base layer, the thermoplastic elastomer for the surface layers includes TPO, styrene-based thermoplastic elastomer, polyamide-based thermoplastic elastomer and polyvinyl chloride-based thermoplastic elastomer, and TPO is preferred. It is desirable that the material for the surface layers is of the same type as that of the material for the base layer in order to improve the adhesiveness between the two layers.

For example, the material of the surface layers may be prepared by kneading 100 parts by weight of TPO that is prepared by kneading from 30 parts by weight to 60 parts by weight of a softener-containing EPDM rubber component and from 40 parts by weight to 70 parts by weight of a polypropylene resin, along with from 2 to 10 parts by weight of a filler that contains at least short fibers and a lubricant. Xn this, preferably, the ratio of the short fibers and the lubricant is approximately 1/1. Also preferably, the hardness of the surface layer is from 35° to 50° in terms of the Shore D-type hardness. Concretely, for example, 40 parts by weight of an EPDM rubber component is kneaded with 60 parts by weight of a polypropylene resin to form the surface layer, and the hardness of the surface layer is 40° in terms of the Shore D-type hardness.

When TPO is used in the surface layer, then its adhesiveness to TPO or EPDM rubber of the base layer is good and its extrusion to form the layer is easy. Therefore, TPO is preferred for the surface layer. However, if the amount of the EPDM rubber component is smaller than 30 parts by weight and that of the polypropylene resin is larger than 70 parts by weight and when the two are kneaded in that ratio to form the surface layer, then the Shore D-type hardness of the surface layer formed will be larger than 50°. If so, the surface layers of the seal lips 14 and 15 will be too hard and the seal lips 14 and 15 of the glass run 10 will lose flexibility and sealability and. On the other hand, if the amount of the EPDM rubber component is larger than 60 parts by weight and that of the polypropylene resin is smaller than 40 parts by weight and when the two are kneaded in that ratio to form the surface layer, then the Shore D-type hardness of the surface layer formed will be smaller than 35°. If so, the surface layers of the seal lips 14 and 15 will be too soft, and therefore the sliding resistance of the seal lips 14 and 15 of the glass run 10 to the window glass 2 will increase and the abrasion resistance thereof will lower. As a result, great force will be needed when the window glass 2 is moved up and down, and some noise may occur when it slides.

The material for the surface layer is prepared by kneading 100 parts by weight of TPO thus prepared in the manner as above, with from 2 to 10 parts by weight of a filler that contains at least short fibers and a lubricant. The short fibers may be synthetic fibers such as fluororesin fibers, polyamide fibers, aromatic polyamide fibers, polyester fibers, acrylic fibers; and inorganic fibers such as carbon fibers, glass fibers. One or more types of these fibers may be used herein, either singly or as combined. The filler that contains such short fibers is introduced into the surface layer and the surface of the surface layer is thereby roughened. As a result, the contact area of the surface layer with a window glass is reduced and the sliding resistance of the surface layer may be further reduced.

Regarding the size thereof, the short fibers preferably have a diameter of from 5 μm to 30 μm and a length of from 100 μm to 1000 μm. If their diameter is smaller than 5 μm, then the fibers will be too thin and will be difficult to handle, and, in addition, the surface roughness of the surface layer that contains such thin fibers will be unsatisfactory, or that is, the thickness of the fibers is not enough to reduce the sliding resistance of the surface layer. On the other hand, if the diameter thereof is larger than 30 μm, then the short fibers will be too stiff and will be difficult to uniformly disperse. If the length of the fibers is shorter than 100 μm and if such too short fibers are added to the surface layer on which window glasses slide, then the short fibers may drop off from TPO; but if longer than 1000 μm, then the resistance in adding such long fibers to TPO will increase and the long fibers will be difficult to uniformly disperse in TPO.

Preferably, the melting point of the short fibers is higher than that of the material of the surface layer into which they are added. When the short fibers are kneaded with a thermoplastic elastomer, the system temperature may be elevated so as to increase the flowability of the thermoplastic elastomer. In such a case, it is desirable that the short fibers can still keep their shape, not melting to dissolve in the thermoplastic elastomer, in order to reduce the sliding resistance of the surface layers 13b, 14b and 15b.

In addition to the short fibers, the surface layer may further contain a lubricant such as fatty acid amide or organopolysiloxane for further reducing the sliding resistance of the surface layers, and a filler such as reinforcing agent. The fatty acid amide may be a higher fatty acid amide including, for example, stearamide, Qleylamide, methylolamide, ethylenebisstearamide. The organopolysiloxane includes, for example, dimethylpolysiloxane, methylphenylpolysiloxane, modified polysiloxane.

An ordinary filler such as calcium carbonate, calcium silicate, clay, talc, silica and molybdenum disulfide may be added to the surface layer. The filler that contains at least such short fibers is kneaded with a thermoplastic elastomer, and it is desirable that the amount of the filler is from 2 to 10 parts by weight relative to 100 parts by weight of the thermoplastic elastomer. If the amount is smaller than 2 parts by weight, then it will be ineffective for reducing the sliding friction resistance of the surface layer; but if larger than 100 parts by weight, the surface layer will be too stiff and its ability to follow the window glass 2 will be not good and its sealability will be also not good. Examples of the softener for the EPDM rubber component are paraffin-type, naphthene-type and aromatic process oils. The glass run 10 of this embodiment is constituted as above. Accordingly, the short fibers are prevented from dropping off from the surface layer and, as combined with the effect of the lubricant, they ensures the reduced sliding resistance of the surface layer for a long period of time.

A method for producing the glass run 10 is described. The glass run 10 may be produced by extrusion. The thermoplastic elastomer to form the base layer is controlled to have a predetermined hardness, as so mentioned hereinabove. A material for the surface layer is prepared by kneading a thermoplastic elastomer with short fibers and other filler, in which the hardness of the elastomer is higher than that of the elastomer for the base layer. The two materials are extruded into 2 layers. Briefly, on the base layer that serves as the body part of the glass run 10, a surface layer is extruded so as to be integrated with the inner face of the bottom wall 13, and with the opposite faces of the outer seal lips 14 and the inner seal lip 15. Since the base layer and the surface layer are made of a thermoplastic elastomer of the same type, they melt and firmly adhere to each other while extruded into 2 layers. The glass run 10, thus formed in such a mode of extrusion, is cut into a predetermined size, and its corners are connected with other molded members to complete a product. In case where the base layer is made of an EPDM rubber, then it is first shaped and vulcanized, and then a thermoplastic elastomer for the surface layer to be thereon is separately extruded out onto it to thereby form the surface layer on the base layer, and the two layers thus separately formed are bonded to each other.

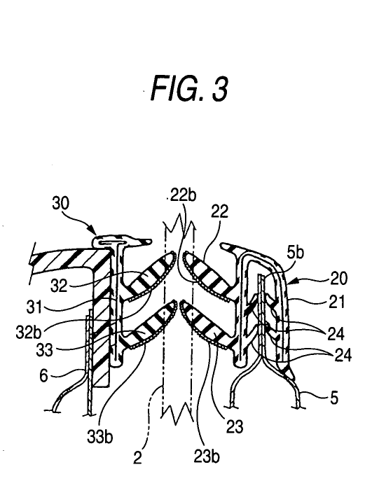

The second embodiment of the invention is described with reference to FIG. 3. In this embodiment, the invention is applied to the outer weather strip 20 and the inner weather strip 30 that are to be fitted to a door belt line, as illustrated. The outer weather strip 20 is fitted to the upper flange 5b of the door outer panel 5 of the door 1 of a vehicle, and this seals up between the window glass 2 of the door 1 and the door outer panel 5. The outer weather strip 20 comprises a mounting base portion 21, an outer upper seal lip 22, and an outer lower seal lip 23.

The mounting base portion 21 of the outer weather strip 20 has an substantially reverse U-shaped cross section, and both inner walls of the reverse U-shaped structure each have two holding lips totaling four, 24, 24, 24, 24 that are integrally formed on the inner walls on which they face each other. The flange 5b of the door outer panel 5 is inserted into the reverse U-shaped structure, and the outer weather strip 20 is mounted and held by the holding lips 24, 24, 24, 24.

On the inside outer face of the mounting base portion 21 of the outer weather strip 20, two upper and lower seal lips, or that is, an outer upper seal lip 22 and an outer lower seal lip 23 are formed, both extending in the inward direction. The outer upper seal lip 22 and the outer lower seal lip 23 are kept in contact with the outer face of the window glass 2 while the window glass 2 slides up and down along them, and they seals up between the window glass 2 and the upper side of the door outer panel 5 of the door 1. In this case, surface layers 22b and 23b are provided on the sliding faces of the outer upper seal lip 22 and the outer lower seal lip 23, respectively, in order that the window glass 2 can smoothly slide through the seal lips. In this embodiment, two seal lips 22 and 23 are provided as upper and lower ones for more ensuring the sealability of the structure with them. Depending on the type of a vehicle, one seal lip alone may be provided.

The material of the base layer except the part of the surface layers 22b and 23b of the outer weather strip 20, and that of the surface layer 22b of the outer upper seal lip 22 and the surface layer 23b of the outer lower seal lip 23 may be the same as the material of the base layer of the glass run 10 and that of the surface layers 14b and 15b of the seal lips 14 and 15 of the glass run 10, respectively. Specifically, the base layer to be the mounting base portion 21, the outer upper seal lip 2 and the outer lower seal lip 23 is made of a thermo plastic elastomer that is softer than the surface layer, or of a solid or slightly-foamed EPDM rubber; and the surface layers 22b and 23b are made of a thermoplastic elastomer that is harder than the base layer and contains short fibers dispersed therein. For the material to be kneaded with the thermoplastic elastomer, the hardness of the layers and the filler such as short fibers in this embodiment, referred to are those mentioned hereinabove for the embodiment of the glass run 10. In this embodiment, the mounting base portion 21 except the seal lips 22 and 23 and the holding lips 24 may be made of a hard resin such as polypropylene or a hard TPO. In this case, the core to be embedded inside the structure may be omitted.

Short fibers are added to the surface layer 22b of the outer upper seal lip 22 and to the surface layer 23b of the outer lower seal lip 23, and therefore the surfaces of the surface layers are roughened. Accordingly, when the window glass 2 slides up and down on the surface layers, the sliding resistance of the surface layers is reduced and the window glass may slide smoothly. In addition, when the window glass 2 slides down, the outer upper seal lip 22 and the outer lower seal lip 23 are not rolled inside the structure. Further, the short fibers are prevented from dropping off from the surface layer, and the surface layer may ensure good slidability for a long period of time. In addition, since the base layer of the outer upper seal lip 22 and the outer lower seal lip 23 is flexible, it ensures good contact with the window glass 2 even when the window glass 2 is vibrated or moved, and it surely seals up the window glass 2.

A method for producing the outer weather strip 20 is described. Basically, this is the same as the method for producing the glass run 10 mentioned above. The mounting base portion 21 of the outer weather strip 20 may have an insert of a metal plate or the like embedded inside it, in order to increase the holding power of the flange 5b. When such an insert is embedded therein and when the mounting base portion 21 is made of a thermoplastic elastomer material, then the outer weather strip 20 may be produced by ter-extrusion. Briefly, the insert, the base layer to cover the insert, and the surface layers 22b and 23b are simultaneously extruded out from one extruder all at a time by ter-extrusion. In this case, the mounting base portion 21, the outer upper seal lip 22, the outer lower seal lip 23 and the holding lips 24, 24, 24, 24 are formed all at a time and are integrated all together. The surface layers 22b and 23b are integrally extruded out on the surface of the base layer, and the surface layers 22b and 23b are made of a thermoplastic elastomer of the same type as that of the base layer. Therefore, they firmly fuse all together just after formed through extrusion. Thus formed in the mode of extrusion, the mounting base portion 21 is bent to a reverse U-shape, then cut into a predetermined size and worked into a final product, outer weather strip 20. When an EPDM rubber is used for the outer weather strip 20, the same as that to the glass run 10 mentioned above may apply to it, except that an insert is embedded in the base layer to be formed by extrusion for the outer weather strip 20.

The inner weather strip 30 is described. The inner weather strip 30 comprises a mounting base portion 31 that is fitted to the door inner panel 6 via a door trim board, and two seal lips, or that is, an inner upper seal lip 32 and an inner lower seal lip 33 that are formed on upper and lower outer side of the mounting base portion 31 to extend in the outward direction. The mounting base portion 31 is tabular and runs in the vertical direction. On the inner side thereof, the mounting base portion 31 is formed in airtight contact with the top end of the door trim board, and this is fitted to it via bolts, clips, adhesive or the like.

The two seal lips, or that is, the inner upper seal lip 32 and the inner lower seal lip 33 extend in the outward direction from the side wall of the mounting base portion 31 of the inner weather strip 30, and these are kept in contact with the inner face of the window glass 2 while the window glass 2 slides up and down. In that manner, the two seal lips seal up between the window glass 2 and the upper side of the door inner panel 6 of the door 1. In this case, surface layers 32b and 33b are formed on the sliding faces of the inner upper seal lip 32 and the inner lower seal lip 33, respectively, for ensuring smooth sliding of the window glass 2 between the two lips. In this embodiment, two seal lips 32 and 33 are provided as upper and lower ones for more ensuring the sealability of the structure with them. Depending on the type of a vehicle, one seal lip alone may be provided, like in the outer weather strip 20 mentioned above.

The material of the base layer except the part of the surface layers 32b and 33b of the inner weather strip 30, and that of the surface layer 32b of the inner upper seal lip 32 and the surface layer 33b of the inner lower seal lip 33 may be the same as the material of the base layer of the glass run 10 and that of the surface layers 14b and 15b of the seal lips 14 and 15 of the glass run 10, respectively. In particular, the surface layers 32b and 33b that characterize the present invention are made of a thermoplastic elastomer that is harder than the base layer and contains short fibers dispersed therein. For the material to be kneaded with the thermoplastic elastomer, the hardness of the layers and the filler such as short fibers in this embodiment, referred to are those mentioned hereinabove for the embodiment of the glass run 10.

Short fibers are added to the surface layer 32b of the inner upper seal lip 32 and to the surface layer 33b of the inner lower seal lip 33, and therefore the surfaces of the surface layers are roughened. Accordingly, when the window glass 2 slides up and down on the surface layers, the sliding resistance of the surface layers is reduced and the window glass may slide smoothly. In addition, when the window glass 2 slides down, the inner upper seal lip 32 and the inner lower seal lip 33 are not rolled inside the structure. Further, the short fibers are prevented from dropping off from the surface layer, and the surface layer may ensure good slidability for a long period of time. In addition, since the base layer of the inner upper seal lip 32 and the inner lower seal lip 33 is flexible, it ensures good contact with the window glass 2 even when the window glass 2 is vibrated or moved, and it surely seals up the window glass 2 and ensures noise insulation.

A method for producing the inner weather strip 30 is described. Basically, this is the same as the method for producing outer weather strip 30 mentioned above. The mounting base portion 31 of the inner weather strip 30 may have an insert of a metal plate or the like embedded inside it, in order to increase the self-sustaining power of the mounting base portion 31. Having the constitution, the inner weather strip 30 may be produced by ter-extrusion. Briefly, the insert, the base layer to cover the insert, and the surface layers 32b and 33b are simultaneously extruded out from one extruder all at a time by ter-extrusion. In this case, the mounting base portion 31, the inner upper seal lip 32 and the inner lower seal lip 33 are formed all at a time and are integrated all together. The surface layers 32b and 33b and the base layer are made of a thermoplastic elastomer of the same type, and therefore they firmly fuse all together just after formed through extrusion. Thus formed in the mode of extrusion, the inner weather strip 30 is cut into a predetermined size and constructed into a product structure.

1. A glass weather strip for holding or sealing sliding a window glass of a vehicle comprising:
a base layer made of a first thermoplastic elastomer softer than a surface layer, or of a solid or slightly-foamed EPDM; and
the surface layer formed on the base layer on which the window glass slides,
wherein the base layer and the surface layer are laminated in a part the glass weather strip on which the window glass slides; and
the surface layer is made of a second thermoplastic elastomer harder than the base layer and containing short fibers dispersed therein to roughen a surface of the surface layer.

2. The glass weather strip according to claim 1, wherein the short fibers comprise at least one of fluororesin fibers, polyamide fibers, aromatic polyamide fibers, polyester fibers, acrylic fibers, carbon fibers and glass fibers.

3. The glass weather strip according to claim 1, wherein the short fibers have a diameter of from 5 μm to 30 μm and a length of from 100 μm 1000 μm.

4. The glass weather strip according to claim 1, wherein the short fibers have a melting point higher than that of the material of the second thermoplastic elastomer.

5. The glass weather strip according to claim 1, wherein a hardness of the base layer is from 60° to 85° in terms of the JIS A-type spring hardness, and a hardness of the surface layer is from 35° to 500 in terms of the Shore D-type hardness.

6. The glass weather strip according to claim 1, wherein the base layer is made of a TPO prepared by kneading from 60 parts by weight to 85 parts by weight of a softener-containing EPDM rubber component and from 15 parts by weight to 40 parts by weight of a polypropylene resin, and the surface layer is made of a material prepared by kneading 100 parts by weight of TPO that comprises from 30 parts by weight to 60 parts by weight of a softener-containing EPDM rubber component and from 40 parts by weight to 70 parts by weight of a polypropylene resin, along with from 2 to 10 parts by weight of a filler that contains at least short fibers.

7. The glass weather strip according to claim 1, wherein the glass weather strip is a glass run including:
a body portion having a substantially U-shaped cross section comprises a bottom wall fitted to an inner periphery of a vehicle door frame and side walls having opposing faces to each other; and
seal lips each extending obliquely from each side wall toward the inside of the U-shaped body portion so as to face each other,
wherein the surface layer roughened by the short fibers on its surface is formed on at least an inner face of the bottom wall.

8. The glass weather strip according to claim 1, wherein the surface layer is made of a material prepared by kneading 100 parts by weight of a third TPO that comprises from 30 parts by weight to 60 parts by weight of a softener-containing EPDM rubber component and from 40 parts by weight to 70 parts by weight of a polypropylene resin, along with from 2 to 10 parts by weight of a filler that contains at least short fibers and a lubricant, and a surface of surface layer is roughened by the short fibers.

9. The glass weather strip according to claim 8, wherein a filler for the surface layer contains short fibers and a lubricant in a ratio of approximately 1/1, and is kneaded in the third TPO.

10. The glass weather strip according to claim 1, wherein at least a part of the short fibers are embedded in the surface layer.
